(19) United States
(12) Patent Application Publication
(10) Pub. No.: US 2004/0053694 A1
(43) Pub. Date: Mar. 18, 2004

(54) Casino open network system architecture

(76) Inventor: Rick Rowe, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 10/243,982

(22) Filed: Sep. 13, 2002

(51) Int. Cl. A63F 9/24; A63F 13/00; G06F 17/00; G06F 19/00

(52) U.S. Cl. 463/42

(57) ABSTRACT

A network architecture for a gaming environment includes a plurality of gaming devices configured to generate and output data and a data repository adapted to collect data provided by the plurality of gaming devices, the data repository including at least one memory device. The network architecture includes a plurality of disparate systems, the systems implementing different applications and/or utilizing different languages or communication protocols/formats, and at least one open interface provided between the plurality of disparate systems, the at least one open interface permitting communications between each of the plurality of disparate systems and the data repository, whereby data collected by the data repository regarding gaming operations may be transmitted to and used by any or all of the plurality of disparate systems, and whereby the plurality of otherwise disparate systems may communicate with one another.

### FIELD OF THE INVENTION

The present invention relates to networks and systems used in casino environments, including those used to collect and analyze gaming machine and other casino event transaction information.

### BACKGROUND OF THE INVENTION

Casinos and other gaming establishments have evolved over time. In the early days, gaming machines were mechanically operated. Monies were collected from these gaming machines manually and counted in a backroom along with monies collected from table game play. Written ledgers were used to track the collected monies, as well as operating expenses such as payroll.

Over time, casinos began to employ new technology, including computers. Casinos began using a variety of different systems and software to accomplish various functions. For example, a casino would purchase one or more computers for a human resource/payroll department. The casino could then input information regarding employees, the amount of time they worked or salary information, and generate payroll data.

Gaming machines also became electronically operated. While the monies collected by the machines were still collected by hand, information could be obtained regarding the operation of the gaming machines apart from a manual count of the collected monies. For example, gaming machines began to include meters which provided raw data regarding amounts of money input or wagered by players, as well as monies paid out in the form of winnings.

Now the casino could have the gaming machines transmit information to a computer or computers where a slot accounting function could be accomplished. This slot accounting function could comprise tracking amounts bet and paid to the gaming machines to determine an amount held by the gaming machines. This information could then be compared to the manual count of monies.

A casino may also utilize other systems, such as a player tracking or reward system and others. Each of these systems, such as payroll, general casino accounting, gaming machine accounting, and player tracking, are independent. In many instances, it is desirable to use data or other information generated or used at one system at another system. This requires that the data or information be manually input into the other system for use.

The present casino environment comprises a plurality of disparate systems, resulting in substantial lost productivity. A method and apparatus for seamlessly integrating various casino functions is desired.

### SUMMARY OF THE INVENTION

The present invention is a configuration or architecture for a network, and more particularly, a network including a plurality of generally disparate systems and devices found in a casino or similar gaming environment. The invention also includes various methods of configuring such a network and permitting communications between devices and systems in a casino.

In one embodiment, a network architecture for a gaming environment of the invention includes a plurality of gaming devices configured to generate and output gaming event data. The network architecture also includes a data repository adapted to collect data provided by the plurality of gaming devices, the data repository including at least one memory device. Also included are a plurality of otherwise generally disparate systems, each of the systems comprising one or more devices implementing one or more applications. In one embodiment, one or more of the systems implement a different application. In another embodiment, one or more of the systems and/or the repository utilize a different communication protocol or language. The network architecture also includes at least one open interface associated with the plurality of disparate systems, the open interface permitting communications between each of the plurality of disparate systems and the data repository, whereby data collected by the data repository may be transmitted to and used at any or all of the plurality of disparate systems.

In one embodiment, a plurality of open interfaces are provided, one open interface associated with each system. In this embodiment, each open interface may be configured as a socket.

In one embodiment of the invention, each open interface comprises an application program interface (API). The API is configured to translate information to or from XML format.

In one embodiment, the at least one open interface permits communication between the plurality of disparate systems. In this configuration, each system may communicate with any other system, although the systems implement different applications and/or use different communication protocols, languages or formats.

In a particular embodiment of the invention, the network architecture comprises a casino floor system comprising a plurality of gaming devices, each gaming device configured to present one or more games and generate data regarding gaming activities, and at least one data repository configured to collected the generated data. The network architecture also includes a main casino system, the main casino system including a plurality of casino applications, and at least one interface provided between the main casino system and the casino floor system permitting communications between the main casino system and the casino floor system. The network architecture also includes a plurality of general casino operating systems, the systems being generally disparate, and at least one open interface, the at least one open interface permitting communications between the plurality of general casino operating systems and the main casino system.

In this embodiment, the plurality of casino applications are selected from the group consisting of: marketing, player tracking, gaming machine accounting, bonusing, promotions, and advertising. The plurality of general casino operating systems include a payroll system and an accounting system.

In accordance with a method of the invention, data is generated by a plurality of casino floor devices, such as gaming machines. The generated data is collected, either temporarily for real-time transmission or for long term storage, at a data repository.

Data is transmitted from the repository to one or more disparate systems via at least one open interface. The open interface serves as an application interface, configuring messages from each system which may be understood by the data repository.

Data may similarly be transmitted from one system to another using one or more open interfaces. The open interface(s) configures messages which may be utilized by systems which implement different applications or otherwise utilize different languages/communication protocols.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of an open network system in accordance with the present invention;

FIG. 1b illustrates effective communication paths between systems of the network illustrated in FIG. 1;

FIG. 2 illustrates one embodiment of a gaming machine of the type which may generate data as part of the system illustrated in FIG. 1;

FIG. 3 illustrates one embodiment of a gaming controller of a gaming machine such as that illustrated in FIG. 2;

FIG. 4 illustrates one embodiment of a message format by which data may be transmitted through the system illustrated in FIG. 1; and

FIG. 5 illustrates a specific implementation of the system illustrated in FIG. 1.

### DETAILED DESCRIPTION OF THE INVENTION

The invention is a data network for a casino or gaming environment, and a method of collecting and using data. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a network. The network is particularly suited for a casino or other gaming environment. The network includes a plurality of data generating devices. These devices may include, for example, gaming machines. Generated data is collected at a data repository. A plurality of disparate applications or systems interface with the single data repository. One or more interfaces permit the applications or systems to interface with one another. In this configuration, a single network includes a plurality of applications or systems which work seamlessly as a single system.

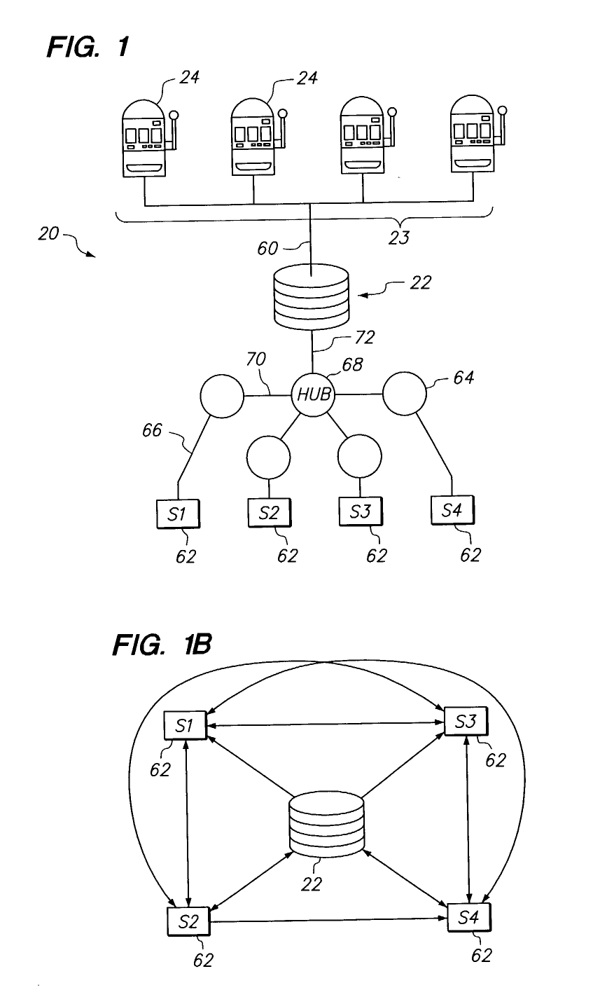

One embodiment of a network 20 in accordance with the present invention is illustrated in FIG. 1. As illustrated, the network 20 includes a central data repository 22. The data repository 22 comprises a device or devices for storing collected data. The repository 22 may comprise, for example, a memory device, such as a semiconductor type memory device (e.g. RAM, EEPROM or other flash memory), a magnetic type memory device (e.g. hard drives), an optical type memory device (e.g. CD/DVD), or other data storage devices now known or later developed. The repository 22 may comprise more than one device, and may include devices which are located remote from one another. Preferably, the data repository 22 includes or is associated with a transaction processor which may be used to perform various functions in association with the data repository, including storing and retrieving data.

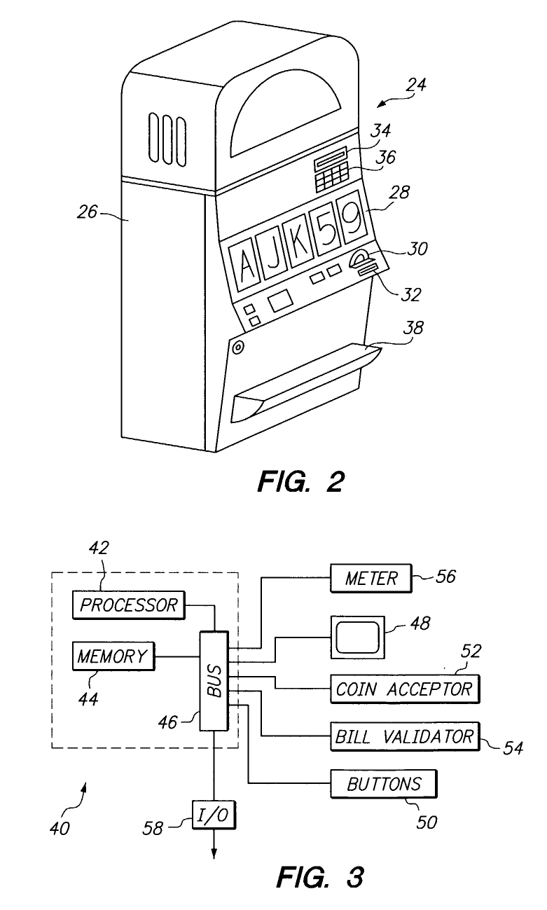

A plurality of data generating devices 23 provide data to the repository 22. In the case of a casino environment, these data generating devices may comprise gaming machines 24. One embodiment of a gaming machine 24 is illustrated in FIG. 2. In general, the gaming machine 24 is adapted to present at least one game for play to a player. As illustrated, the gaming machine 24 includes a housing 26 which supports and/or houses the various components of the gaming machine 24.

In one embodiment, the gaming machine 24 is a “video” type machine in which game information is displayed to a player. In this regard, the gaming machine 24 includes a display 28. The display 28 may be of a variety of types, as is known, such as CRT, LCD, plasma and the like.

The gaming machine 24 includes a variety of controls and other features for presenting a game utilizing the display 28. In one or more embodiments of the invention, the gaming machine 24 is adapted to present a wager-type game. In this arrangement, a player is required to place a bet or wager in order to participate in the game. In the event the outcome of the game is a winning outcome, then the player may be provided with an award. In one arrangement, the award may be winnings based upon the amount wagered or bet by the player.

In order to accept a wager, the gaming machine 24 may include a coin acceptor 30 for accepting coins. The gaming machine 24 may also include a bill acceptor or validator 32 for accepting paper currency. The gaming machine 24 may be provided with other means for accepting or verifying value, such as a credit card reader.

In one embodiment, the gaming machine 24 may include a card reader 34 for reading credit cards and/or player tracking cards. A keypad 36 or other input device may also be provided which permits a player to enter information, such as player identification information such as a password or PIN. Such player tracking devices, including various input devices which may be employed, are well known.

The gaming machine 24 may include a variety of player input devices. For example, push-type buttons or other input accepting elements may be provided. A player may utilize these buttons to place bets, initiate games and the like. Such input devices and their operation are well known.

In one embodiment of the game, a player may be awarded a prize or payout if the outcome of the game comprises a predetermined winning outcome. In one embodiment, the award may be paid in coins, such as to a coin tray 38. In other embodiments, the award may be paid as a ticket, electronically indicated credit or the like.

It should be understood that the gaming machine 24 may be adapted to present one or more of a wide variety of games. Depending upon the game presented, the configuration of the machine may vary.

FIG. 3 illustrates one embodiment of a control system 40 for a gaming machine, such as the gaming machine 24 illustrated in FIG. 2. In general, the gaming machine controller 40 is arranged to facilitate the presentation of a game to a player of the gaming machine.

In one embodiment, the gaming machine controller 40 includes a processing device 42, such as a processor manufactured by AMD or Intel. Preferably, the controller 40 also includes a memory 44. The memory 44 comprises a device configured to store data. The device may be of a variety of types. In one embodiment, to facilitate high speed data storage and access, the memory is a semiconductor device, such as RAM or EEPROM or a flash type memory.

The processor 42 and memory 44 are associated with a bus 46. The bus 46 permits the transport of data, in the form of signals, from one device to another. For example, the memory 44 is arranged to store information, such as game software/code, which may be transmitted to the processing unit 42 for execution. The processing unit 42 outputs instructions/data through the bus 46 for controlling one or more peripheral devices of the gaming machine for presenting the game.

The peripheral devices may vary. As illustrated, the peripheral devices may include a display 48. In the case of a slot game, the display 48 may comprise one or more reels. In the case of video poker and other games, the display 48 may comprise a CRT, LCD or the like. Other peripherals may include the above-referenced keys or buttons 50 for accepting user input, a coin acceptor 52, and a bill validator 54. The peripherals may also include a meter 56 which tracks information regarding the amounts paid to and paid by the gaming machine.

The gaming machine controller 40 may be located in an internal portion of the gaming machine. In general, the arrangement of a gaming controller and its method of operation in presenting a game is well known.

Preferably, the gaming controller 40 includes a communication interface 58. The communication interface 58 preferably permits bi-directional communication to and from the gaming controller 40 and other device. The communication interface 58 may comprise a wide variety of devices. For example, the communication interface 58 may comprise a modem or a PC type card including an antenna for implementing a wireless communication protocol such as Bluetooth. The communication interface 58 may comprise a PC type card facilitating a protocol over a wired network, such as Ethernet or Firewire®.

Referring again to FIG. 1, a communication pathway or link 60 is provided between each data generating device 23, such as each gaming machine 24, and the data repository 22. The communication pathway or link 60 permits data to be transmitted from the gaming machine 24 to the data repository 22. The pathway or link 60 may comprise a wired or wireless communication pathway. For example, if the link is a wireless link, the protocol/architecture may be Bluetooth, infrared or IEEE 802.11x. For wired links, the protocol/architecture may be USB, RS-485, IEEE-1394 (Firewire®), Ethernet, or TCP/IP. It will be appreciated that the configuration of the communication interface 58 associated with the gaming machine 24 may vary depending upon the form of the communication link 60.

Though not illustrated, the device or devices comprising the data repository 22 preferably include a communication interface.

Though not illustrated, the data generating devices 23 may comprise devices other than gaming machines 24. For example, the data generating devices 23 may comprise player tracking devices or monetary acceptors located at gaming tables.

As described in greater detail below, data generated by the data generating devices 23, such as the gaming machines 24, may be transmitted to the data repository 22. This data may be stored at the repository and/or transmitted on to another device or location.

Still referring to FIG. 1, the system 20 includes a plurality of systems 62. In the embodiment illustrated, there are four systems 62. There may be a greater or lesser number of systems than the number illustrated in FIG. 1.

Each system 62 may comprise a variety of devices or components. For example, each system may include a plurality of computing devices and servers. In one embodiment, each system 62 includes hardware or software for implementing one or more applications or tasks. For example, as described in greater detail below, in the casino environment, the tasks may be player tracking, gaming machine accounting, payroll, and marketing.

The systems 62 may comprise devices or components in a variety of locations. In one embodiment, one or more of the components of the system are linked by one or more communication links. For example, the system 62 may comprise a plurality of computers all in communication with one or more hosts or servers via one or more communication links. As with the communication link 60 described above, the type and form of the link or links may vary. In one embodiment, the system 62 may be configured as a local area network (LAN). In other embodiments, the system 62 may be configured as a wide area network (WAN).

In one embodiment of the invention, one or more or all of the systems 62 may generally referred to as “disparate.” By “disparate,” it is meant that the system 62 is generally configured to operate or function independently of any other system 62. In one or more embodiments, one or more of the systems 62 embody or implement different applications. In another embodiment, the one or more systems 62 use a language and/or communication protocol and/or information or data format which varies from that of another system and/or the data repository 22. In this configuration, each system 62 may be independently configured to achieve, with greatest efficiency, the desired function. In such a configuration, however, one or more or all of the systems 62 may not directly be able to communicate with one another and/or may not be able to communicate with the data repository 22.

In a preferred embodiment of the invention, the system 62 includes one or more open interfaces 64. Each open interface 64 may comprise hardware and/or software. The term “software” as used herein is meant to include computer readable program code, such as code which may be executed by a general or special purpose computer processor. The application of computer code may be embodied in any form of computer program product, the computer program product comprising a medium for storing or transporting the code, or in which the code may be embedded. Some examples of computer program product include CD-ROM disks, hard drives, semi-conductor type memory devices and others.

The location of the open interfaces 64 may vary. As described in greater detail below, each open interface 64 permits communication between one or more of the systems 62 and the data repository 22. In one embodiment, each open interface 64 permits communication between one or more of the systems 62 and another system 62.

In one embodiment, as illustrated, an open interface 64 is associated with each system 62. Thus, when there are four systems 62, as illustrated, there are at least four open interfaces 64. In this embodiment, each open interface 64 may be configured as a socket. Each system 62 “plugs in” to the socket.

In a preferred embodiment, each open interface 64 is configured as an application program interface (API). The API may be implemented as software executed by a processing device. In one embodiment, the API software may be executed by hardware of the system 62. For example, where the interface 64 is configured as a socket, the API software may be executed by a processing device of a main server of the system 62. In another embodiment, the API software may be implemented on an independent device, such as a dedicated remote server or other computing device.

As illustrated, each system 62 is in communication with its open interface 64 by at least one communication link 66. In an embodiment where the API software is executed by a processing device of the system 62, the link 66 may be an internal link. For example, the link 66 simply comprise an instruction invoked during execution of the main application which causes the API software to be executed.

In an embodiment where the API is implemented on a device or devices independent of the system 62, the communication link 66 may comprise a wired or wireless communication link. As indicated above, such a link may be implemented using various hardware and/or software and utilize a variety of protocols or architectures.

Each open interface 64 permits communication between its associated system 62 and the data repository 22. In one embodiment, a direct communication path is provided between each open interface 64 and the data repository 22. In another embodiment, as illustrated, the open interfaces 64 are connected to the data repository 22 via one or more hubs 68. The hub 68 may comprise hardware and/or software which serves as a router, directing data from the plurality of interfaces 64 to the data repository 22 and directing data from the repository 22 to the interfaces 64. As is known, such a routing device may utilize various forms of addressing to accomplish this function and may operate as a packet-switched network.

In this embodiment, each open interface 64 is connected to the hub 68 by at least one communication link 70. As described above, such a communication link 70 may have a variety of forms, being wired or wireless, and may use various protocols and architectures.

In this embodiment, the hub 68 is connected to the data repository 22 with at least one communication link 72. Once again, this communication link 70 may have a variety of forms, being wired or wireless, and may use various protocols and architectures.

In one embodiment, the hub 68 may be directly associated with the data repository 22. In this configuration, the data repository 22 may be configured as a server.

In the embodiment illustrated, each system 62 may communicate with any other system 62 through its respective open interface 64. For example, as illustrated in FIG. 1, system S1 may communicate with system S3 through their respective open interfaces 64 and the hub 68. FIG. 1b illustrates the effective configuration of this arrangement. As illustrated, in this configuration communication paths effectively exists between each and every system, permitting each system to communicate with any other system and the data repository.

In accordance with one embodiment of the invention, the open interfaces 64 comprise or embody an API which permits the open interfaces 64 to communicate with their respective systems 62, as well as with one another.

In one embodiment, each system 62 is configured as the “client” and the open interface 64 is configured as the server. Data which is communicated between the open interface 64 and the server 62 may be encrypted and authenticated. For example, in one embodiment, secure socket layer (SSL) protocol may be utilized.

The interface 64 and its system 62 are preferably time synchronized. In one embodiment, time synchronization is accomplished using timeservers that implement the standard network time protocol (NTP). Software is available from a variety of sources to implement this function.

In one embodiment, each API comprises an application which serves as a translator, converting information from or to the language of the associated system or application. In a preferred embodiment of the invention, the API comprises a translator application which converts information from XML to the language of the system or application, and information from the language of the system or application to XML.

XML is a language in which information is coded as both text and data. XML uses “tags” defining the structure and content of the data. The tags are user-definable. As a result, the API comprising the open interface 64 may be custom-configured to include tags for custom-defining the structure and content of data which is suitable for use with the particular system or application with which the API is to interface.

In one embodiment, each open interface 64 is configured to translate information into XML format. This XML coded data may then be transmitted to and recognized by any other open interface 64, and then decoded or translated in to the particular language of its associated system 62.

In one embodiment, the data repository 22 may be configured as an XML server. In this manner, incoming information encoded in XML, such as a request for data from a server 64, or data which is being transmitted from the data repository 22, is in XML and compatible with the other elements of the system 20. XML software and servers are available from Software AG of Darmstadt, Germany. One XML server is the Tamino XML server from Software AG.

In another embodiment, the data repository 22 may utilize a language other than XML. In this configuration, an open interface may be associated with the data repository 22. In that manner, information received from other open interfaces 62 may be translated, and outgoing information may be into, XML.

Of course, the open interfaces 62 may be configured in other manners, including to convert information to or from other languages or formats.

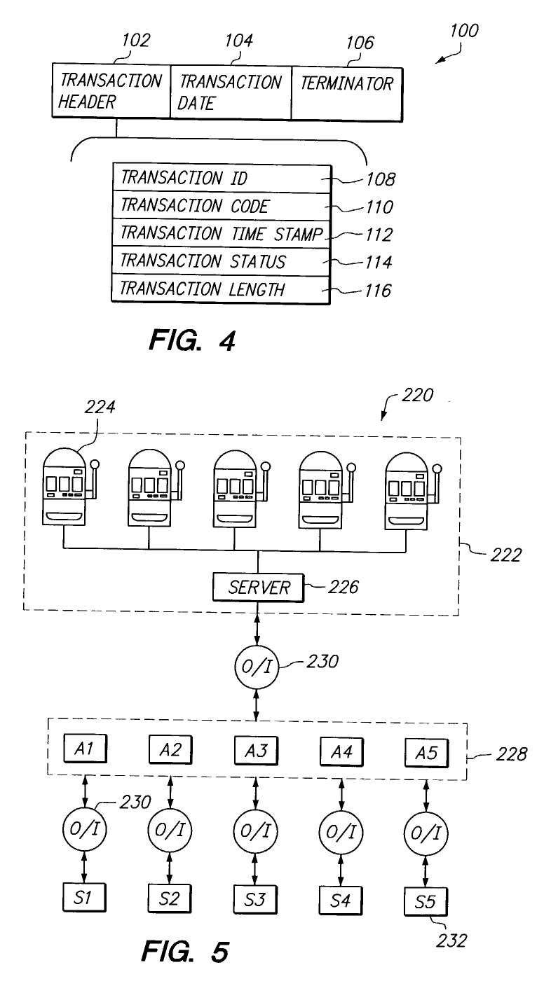

In one embodiment, as illustrated in FIG. 4, data or information is configured in the form of a message 100. The message 100 may have a variety of forms. As indicated above, XML permits messages to have forms which include user-defined tags.

FIG. 4 illustrates one embodiment of an exemplary message 100, the message format including a transaction header 102, transactional data 104, and a terminator 106. In one this embodiment, the messages are in ACSII text format.

In addition, each message 100 may be required to employ particular field formats. For example, general rules regarding numeric, text/string and date/time values may be implemented.

In the exemplary embodiment, each transaction header 102 includes multiple fields or elements of information. In one embodiment, the transaction header 102 includes a transaction ID 108. The transaction ID 108 is a unique identifier for the message. The transaction ID 108 may be, for example, a six-digit numeric value which starts with 000001 and ends at 999999 before rolling over. In one embodiment, when a message 100 is transmitted, the transaction ID 108 is transmitted and continues to be retransmitted until the recipient responds.

The transaction header 102 may include other information, as well. In one embodiment, the transaction header 102 includes a transaction code 110. The transaction code 110 may be used to identify a particular type of transaction. In one embodiment, the transaction code 110 may comprise a two-digit numeric value between 01 and 99, each code corresponding to one or more identified transaction types.

In one embodiment, the transaction header 102 includes a transaction time stamp 112. The time stamp 112 preferably provides information regarding the time the message 100 was sent. The information may comprise numeric data representing the year, month, day, hour, minute and second the message was sent.

In one embodiment, the transaction header 102 includes transaction status information 114. The transaction status information 114 may be of a variety of types. In one embodiment, the transaction status information 114 is a three-digit numeric code ranging between 000 and 999, each code representing a particular status. The status codes may represent, for example, the status of the prior message, including whether the message transaction was successful, or providing information regarding particular errors which occurred.

In one embodiment, the transaction header 102 includes transaction length information 116. The transaction length information 116 provides information regarding the length of the particular transaction which follows as part of the message 100. The transaction length information 116 may comprise, for example, a three-digit numeric code ranging from 000 to 999. Each value may represent a particular size or length of transaction/message to follow, or a range of sizes/lengths.

In this configuration, information or data is transmitted to and from the open interfaces 64 and/or the data repository 22 using a particular message format. It will be appreciated that communications within the system 62 may utilize an entirely different format.

A variety of transaction protocols or methods may be used to particularly implement the message transactions. In one embodiment, as described, when a message is being transmitted, the transaction ID 108 is first transmitted. Once a response is received from the receiving device, the other information from the transaction header 102 may be utilized. For example, the transaction status information 114 may be used to verify that no error occurred during transmission of the last message.

In accordance with the invention, this type of messaging format may also be used to permit each gaming machine 24 or other data generating device 23 to communicate with the data repository 22. For example, XML format might be used to transmit data from the data generating devices 23 to an XML server comprising the data repository.

As described below, in one embodiment, the data generating devices 23 may all be part of a casino floor system. This floor system itself may utilize a particular communication language and protocol which varies from that of the systems 62 and of the data repository 22. In such an event, an open interface may be utilized to permit the data generating devices 23 to communicate with the data repository 22.

In this configuration, the gaming machines 24 may all communicate with a central gaming machine server (not shown). The communication link 60 may then be provided between the main floor or gaming machine server and the data repository 22.

As described above, in one embodiment, an open interface may be associated with the data repository 22. This open interface may be used to configure data or messages for transmission to the other open interfaces 64 when transmitting messages/data to the systems 62, and for receiving messages.

The open interface 64 may be configured in a variety of manners. As illustrated in FIG. 1, an open interface 64 is associated with each system or application. The open interface 64 comprises a translator for that particular system or application.

In another embodiment, a single open interface may be utilized. This single open interface may comprise an API which is capable of translating information from a plurality of languages into XML or another format. In this embodiment, the open interface 64 may be configured as an API having multiple modules. The various modules may be configured specifically to permit communications with and between devices using a particular communication protocol/language. In this fashion, a “generic” API may be configured which permits communication with systems or applications using different communication protocols/languages.

One method of the invention comprises a method of configuring a system as described. In one embodiment, this method includes the step of associating one or more open interfaces with one or more systems as described above. The method may also include the step of configuring a central data repository and associating an open interface with that repository.

One embodiment of the invention comprises a method of collecting and utilizing data in a casino or other gaming environment. One embodiment of such a method will be described with reference to FIG. 1.

In general, data is generated by the one or more data generating devices 23. In the embodiment, the data is gaming event data. For example, referring to the gaming machine 24 illustrated in FIG. 2, data may be generated when a player inputs coins into the coin acceptor 30 or bills into the bill acceptor 32. Referring to the controller 40 illustrated in FIG. 3, such an event may cause a signal to be transmitted from that peripheral device to the processor 42. The processor 42 increments the meter 56, which generates a signal regarding the monetary value provided. This signal may be transmitted from the gaming machine 24 to the central repository 22. In this fashion, data, such as a meter event representing coins (or other value) provided to or paid out by the gaming machine 24, is provided to the central data repository 22.

It will be appreciated that the type of data which is generated and provided to the data repository 22 may vary. The data may comprise, for example, data regarding events other than meter or monetary values. For example, information such as player tracking events, including a player's insertion of their player tracking card, may be generated and transmitted.

Information or data which is transmitted to the data repository 22 may be stored and/or retransmitted. In one embodiment, some or all of the data is stored in mass storage for later retrieval and use. In one embodiment, some or all of the data is only temporarily stored before being retransmitted. In this embodiment, the storage is short-term, only for the period of time necessary to configure an appropriate message by which the data may be transmitted on from the data repository 22 to the next device.

Information which is retransmitted from the data repository 22 may be transmitted directly to one or more of the systems 62 for immediate use. As indicated, the data may be transmitted as part of a particularly configured message generated by an API associated with the data repository 22. This message is directed to the appropriate system 62 through its open interface 64. It will be appreciated that an address is associated with the data/message for routing it to the appropriate location. Once the message reaches the open interface 64 of the destination system 62, the message may be converted (i.e. translated into the language/format used by the system) for use by the system.

Data may also be transmitted from each system 62 to the data repository 22. For example, one of the systems 62 may generate and send a message comprising a request for particular information. In this case, a message is generated and transmitted from the open interface 64 of that system 62 to the data repository 22.

Data and other information may also be transmitted to and from each of the systems 62. For example, one system 62 may generate particular data from data obtained from the data repository 22. This manipulated or compiled data may be transmitted from this system 62 directly to another system 62. This is accomplished by transmitting the data through the open interfaces 64 and hub 68.

A variety of other configurations of systems 20 are contemplated within the scope of the invention, and the system of the invention may be implemented in a variety of forms. One particular embodiment of an implementation in a casino environment is illustrated in FIG. 4.

This embodiment system 220 includes a casino floor system 222. Casino floor systems 222 are known and exist in nearly all casinos. The casino floor system 222 links the various gaming machines 224 or other devices. As described above, the floor system 222 may comprise a variety of devices, including hardware and software. In general, the floor system 222 permits communications between each gaming machine 224 and a server or host 226. The server or host 226 may perform a variety of functions, such as be used to implement a player tracking or other rewards function, machine accounting and others.

In accordance with an embodiment of the invention, the system 220 includes a casino system 228. A variety of casino systems 228 are known. The casino system 228 is configured to perform one or more functions. In one embodiment, as illustrated, the functions of the casino system 228 are implemented by a plurality of applications or sub-systems A1-A5. There may be as few as one and greater than five applications or sub-systems. The applications may be implemented as software executed by one or more processing devices. In another embodiment, the functions may be implemented by a plurality of sub-systems including hardware and/or software.

The functions which are implemented by applications or sub-systems may vary. In one embodiment, the functions which are implemented directly by the casino system 228 are functions related to the control and operation of the gaming machines 224. For example, in the gaming environment, the applications may include marketing, player tracking and/or rewards, patron management, bonusing and promotions, gaming machine accounting and advertising. In general, these functions relate to the content of material displayed or disseminated by or at the gaming machines or other devices through the casino, and the operation of the gaming machines or devices, including monetary accounting and implementation of promotions, bonuses or other awards at the gaming machines.

In one embodiment, the system 220 includes an open interface 230 between the floor system 222 and the casino system 228. The open interface 230 may be configured as above and permits the disparate floor and casino systems 228 to communicate with one another. For example, raw data generated and collected at the server 226 of the floor system 222 may be transmitted to and utilized by the casino system 228. For example, gaming machine 224 meter data may be used by a gaming machine accounting application or system of the casino system 228.

In one embodiment, a plurality of general systems 232 are associated with or connected to the casino system 228 and/or floor system 222. These general systems 232 or applications may vary. Generally, these systems 232 may be general casino operating functions, such as payroll, general casino business accounting, including a general ledger or other functions, finance, human resources and others. The functions may be configured to track and pay employees, track overall casino revenues and expenses and the like.

As illustrated, five systems A1-A5 are in communication with the casino system 228. There may be a greater or lesser number of systems than the number illustrated in FIG. 4. The systems and their configurations may vary. For example, the payroll function may be implemented using a payroll server and a plurality of associated workstations.

Each general system 232 communicates with the casino system 228 via the open interface 230. Such an interface 230 is described above in greater detail.

In this embodiment, the systems 232 may also communicate with one another. The systems 232 may also communicate with the floor system 222. For example, a general accounting system 232 may communicate with the floor system 222 to obtain gaming machine 224 meter data in order to compile revenue information. In this configuration, the data which is generated and stored at the floor system 222 may be “raw” or undigested data. Thus, the data may need to be filtered or otherwise manipulated for its intended use. On the other hand, the general accounting system 232 could communicate with a gaming machine accounting application of the casino system 228. The gaming machine accounting application could already have filtered and manipulated the raw gaming machine data to provide a modified or derived set of data. The accounting system 232 could use this derived set of data as part of the overall data used to generate complete casino accounting information.

Other configurations of apparatus and method are contemplated. It will be appreciated that the principles of the invention may be applied to a variety of systems, including layers of systems. The invention may also be applied to a wide variety of environments.

In one embodiment, the network may span multiple casinos or properties. For example, a single company may own multiple casinos. Each casino has its own casino floor with data generating devices. In accordance with the invention, data may be transmitted to a single central data repository from all casinos and then the casino systems associated with the various casinos may access this data repository or any other system of that or another casino. In another embodiment, each casino may have its own data repository, but once again all systems of all casinos may access the systems and repositories of another casino.

In one embodiment, the network may be accessed from a remote location, such as a computer at a regulatory agency. In this configuration, one of the sockets may be configured as a network interface, a dedicated communication link may be provided or the like. This permits, for example, an application at remote location (such as a regulatory body, external auditing agency or the like) to access the network including the data at the repository and any of the systems of the network.

The system and method of the invention have numerous advantages. In accordance with the invention, an open network system architecture is provided. The architecture is referred to as “open,” in that a plurality of systems and sub-systems may communicate with one another, even though the systems are otherwise disparate.

One advantage of the network of the invention is realized when considering existing casino structures. As indicated, many casinos already have disparate payroll, accounting, and floor or other gaming systems. In accordance with the invention, these otherwise disparate systems are linked, allowing the systems to communicate with one another. This configuration has the advantage that information generated or existing at one system may be used by another system directly, and without the need to manually input or provide the information to that other system.

Another advantage of the invention is that it permits a casino to select the “best of breed” applications or systems which they desire to be used. In other words, a casino may select the accounting system which best meets their needs independently of the payroll system which best meets their needs, even though the two systems may be entirely different, operating using different languages or protocols. No longer is a casino required to purchase all systems or applications from the same vendor in order to ensure compatibility.

A primary advantage of the invention is that the invention permits a variety of casino systems to be integrated. As indicated, by integrating these systems, inefficiencies such as the need to re-input data or the like is eliminated.

One advantage of one embodiment of the invention is the use of a central data repository. In accordance with this embodiment, a single source of data is provided. A plurality of systems may seek data from that single source. This efficient configuration prevents problems associated with storing data in a variety of locations, where data may be lost or which significantly increases the difficulty of finding the data. This configuration is akin to a “hub and spoke” configuration.

Another significant advantage of the invention is that the various systems or applications are also permitted to now communicate with one another. In this configuration, the systems or applications are similar to “nodes,” each node capable of communicating with any other node. In this respect, there is true integration of all systems.

In accordance with the invention, data may be provided to the various systems in real time, or by access to stored data. Thus, though a central data repository is used, the need for data in real time is not inhibited. For example, in the case of a player tracking function, when a player tracking card is inserted, this event may trigger a player tracking system providing player account information back to the player via a gaming machine display. In accordance with the invention, the card-in event information is transmitted in real time to the player tracking system.

One aspect of the invention is the ability to provide data to a variety of otherwise disparate systems in real time or on demand. In the past, the general accounting department might have to wait for several weeks for slot accounting data to be generated from within the slot accounting department. In addition, a delay occurred because this generated data would then have to be manually input to the general accounting system.

In accordance with the invention, casino employees in various departments and performing a variety of different tasks or functions have access to information from any other system linked in accordance with the invention. Thus, a casino employee may seek information or data on demand, even if the information or data is associated with an entirely different system. Decisions can be based on real-time or updated data, instead of data which may be days or weeks old.

It will be understood that the above described arrangements of apparatus and the method therefrom are merely illustrative of applications of the principles of this invention and many other embodiments and modifications may be made without departing from the spirit and scope of the invention as defined in the claims.

What is claimed is:

1. A network architecture for a gaming environment comprising:
a plurality of gaming devices configured to generate and output data;
a data repository adapted to collect data provided by said plurality of gaming devices, said data repository including at least one memory device;
a plurality of disparate systems, each of said systems comprising one or more devices, one or more of the systems utilizing a particular communication protocol which is different than another system or the data repository; and
at least one open interface provided between the plurality of disparate systems, said open interface permitting communications between each of said plurality of disparate systems and said data repository, whereby data collected by said data repository may be transmitted to and used at any or all of the plurality of disparate systems.

2. The network architecture in accordance with claim 1 wherein an open interface is associated with each system of said plurality of systems.

3. The network architecture in accordance with claim 1 wherein said at least one open interface comprises an application program interface (API).

4. The network architecture in accordance with claim 3 wherein said API is configured to transmit data using a message format.

5. The network architecture in accordance with claim 3 wherein said API is configured to utilize the XML format.

6. The network architecture in accordance with claim 5 wherein said API is configured to translate information between XML and at least one other format.

7. The network architecture in accordance with claim 1 wherein said at least one open interface permits communication between said plurality of disparate systems.

8. The network architecture in accordance with claim 1 wherein said plurality of gaming devices and said data repository are part of a casino gaming system.

9. The network architecture in accordance with claim 1 wherein said plurality of disparate systems include a payroll system and an accounting system.

10. The network architecture in accordance with claim 1 wherein said systems are associated with different casinos.

11. The network architecture in accordance with claim 1 wherein at least one open interface is configured as a remote access point by which the system may be accessed from a remote device.

12. A network architecture for a gaming environment comprising:
a casino floor system comprising:
a plurality of gaming devices, each gaming device configured to present one or more games and generate data regarding gaming activities; and
at least one data repository configured to collected said generated data; and
a main casino system, said main casino system including a plurality of casino applications;
at least one interface provided between said main casino system and said casino floor system permitting communications between said main casino system and said casino floor system;
a plurality of general casino operating systems, said systems being generally disparate; and
at least one open interface, said at least one open interface permitting communications between said plurality of general casino operating systems and said main casino system.

13. The network architecture in accordance with claim 12 wherein an open interface is associated with each of said general casino operating systems.

14. The network architecture in accordance with claim 12 wherein said plurality of casino applications are selected from the group consisting of: marketing, player tracking, gaming machine accounting, bonusing, promotions, and advertising.

15. The network architecture in accordance with claim 12 wherein said plurality of general casino operating systems include a payroll system and an accounting system.

16. The network architecture in accordance with claim 12 wherein said at least one interface comprises an open interface.

17. The network architecture in accordance with claim 12 wherein each open interface comprises an application program interface.

18. The network architecture in accordance with claim 17 wherein said application program interface is configured to translate information into and from XML format.

19. The network architecture in accordance with claim 17 wherein said application program interface implements a message format compatible with said plurality of general casino operating systems and said main casino system.

20. The network architecture in accordance with claim 12 including at least one second casino floor system, at least one second main casino system and at least one additional plurality of general casino operating systems of at least one second casino, and at least one open interface permitting communications between said general casino operating systems and said main casino systems of said casinos.

21. The network architecture in accordance with claim 12 wherein at least one open interface is configured as a remote access point by which the system may be accessed from a remote device.

22. A network architecture for a gaming environment comprising:
a plurality of gaming devices configured to generate and output data;
a data repository adapted to collect data provided by said plurality of gaming devices, said data repository including at least one memory device;
a plurality of disparate systems, each of said systems comprising one or more devices, one or more of the systems embodying an application which differs from that of another system; and
at least one open interface provided between the plurality of disparate systems, said open interface permitting communications between each of said plurality of disparate systems and said data repository, whereby data collected by said data repository may be transmitted to and used at any or all of the plurality of disparate systems.

23. The network architecture in accordance with claim 22 wherein at least one of the applications utilizes a different language than the data repository or another system.

24. The network architecture in accordance with claim 22 wherein said open interface comprises an application interface configured to translate information into or from XML format.

25. The network architecture in accordance with claim 22 wherein said systems are associated with different casinos.

26. The network architecture in accordance with claim 22 wherein at least one open interface is configured as a remote access point by which the system may be accessed from a remote device.
